(19) United States
(12) Patent Application Publication
(10) Pub. No.: US 2005/0241894 A1
(43) Pub. Date: Nov. 3, 2005

(54) Disc brake with an electric motor driven adjustment device and method for controlling a disk brake

(76) Inventors: Johann Baumgartner, Moosburg (DE); Guenther Gschossmann, Ampfing (DE); Laszlo Palkovics, Schwieberdingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/504,530

(22) PCT Filed: Feb. 12, 2003
(86) PCT No.: PCT/EP03/01366

§ 371 Date: May 9, 2005

(30) Foreign Application Priority Data
Feb. 13, 2002 (DE) 102 06 088.6

(51) Int. Cl. F16D 51/00

(52) U.S. Cl. 188/79.51; 188/1.11 W; 188/157

(57) ABSTRACT

A disc brake, especially for commercial vehicles, comprising a brake caliper overlapping a disc brake, a brake application device which is arranged in the brake caliper and pneumatically actuated or actuated by an electric motor for applying a brake, and at least one electric-motor driven adjustment device, characterized in that said disc brake comprises a control device which is arranged on or in the disc brake for controlling at least on electric-motor driven adjustment device. The method for controlling a disc brake according to the one of the above-mentioned claims is characterized in that the adjustment device of the disc brake is controlled by a control device which is directly integrated into the disc brake.

### BACKGROUND AND SUMMARY OF THE INVENTION

The invention relates to a disc brake and to a method of controlling the disc brake.

Disc brakes with electric-motor-operated adjusting systems are known per se; such as, for example, from German Patent document DE 197 56 519 A1, German Patent Document DE 37 16 202 A1, or International Patent Document WO 99/05428.

Pneumatically operated disc brakes are normally equipped with automatic mechanically operating wear adjusting devices for maintaining a correct brake release play.

These wear adjusting devices are activated during each operation of the brake by one of the components of the application mechanism and correct for the brake release play, which may become too large, by performing an adjusting movement of the lengthwise variable pistons of the brake control.

Such mechanically operating wear adjusting devices are incapable of enlarging the release play again, which may become too small, because of the thermal expansion of the brake disc and the brake pads.

This is the significant advantage of independently controlled wear adjusting systems, which can be implemented, for example, by the use of an electric-motor drive when a suitable electronic control system is used.

The idea of the electric adjusting motor for driving the adjusting device of the disc brake has been successful per se.

It is also an advantage that, in the event of a servicing of the disc brake, the adjusting screws are automatically returned into their initial position via the electronic control of the adjusting system to allow for the replacement of the worn-out brake pads with new ones.

Release-play-measuring systems are known, like those which, during the setting operation, first completely eliminate the release play and then set the desired release play by screwing the threaded screws of the lengthwise variable pistons in the backward direction.

The last-mentioned construction has the advantage that no additional sensors are required for setting the release play. It is disadvantageous, however, that a release play setting as a function of the requirement necessitates a recognition of the braking operation, and corresponding signals of other vehicle systems are required for this purpose (brake light switch, CAN connection to the EBS, if present).

This limits the applicability of these electric wear adjusting systems to an extreme extent, because commercial vehicles of the different application categories have completely different equipment in this regard.

It is a particular disadvantage that the disc brake of the above-mentioned type is not independent of external electric or electronic vehicle systems arranged outside the disc brake, particularly control units, such as ABS or EBS control units.

It is a task of the invention to solve this problem.

This problem is solved by providing a disc brake, particularly for commercial vehicles, having a caliper straddling a brake disc, a brake application device, which is arranged in the caliper and is pneumatically or electromotively operable, for applying the brake, at least one adjusting device with an electric-motor drive for compensating brake pad wear by adjusting the release play of the disc brake particularly having at least one adjusting rotating device on each side of the brake disc, which act by way of at least one pressure piece respectively upon the brake pads on both sides of the brake disc, and a control device arranged on, or in, the disc brake, for controlling at least the at least one electric-motor-driven adjusting device. The invention also solves this problem by providing a method of controlling such a disc brake wherein controlling of the adjusting device of the disc brake is carried out by the use of a control device directly integrated in the disc brake. Advantageous further developments are described and claimed herein.

According to the invention, a control device arranged on or in the disc brake is provided for controlling at least the at least one electric-motor-driven adjusting device; in particular, it is integrated directly in the disc brake.

The invention also provides a method of controlling such a disc brake, by which the controlling of the adjusting device of the disc brake is carried out by the use of a control device integrated directly in the disc brake.

The integration of the control device in the disc brake considerably expands the usage range of the disc brake. High-expenditure connections from the brake to a higher-ranking control device can be eliminated. Under certain circumstances, it may be sufficient to feed only electric energy to the disc brake. Optionally, naturally also an additional transmission of information or data between a higher-ranking or other control device at the vehicle is contemplated.

According to another, particularly advantageous variant, the control device is arranged on the outside of the caliper, preferably in a housing, which is attached to the caliper. In particular, the control device and/or the driving motor of at least one adjusting device are integrated in a housing arranged on the exterior side of the caliper.

Preferably, it should be possible to fasten the housing together with the motor in a module-type manner to the caliper. As a result, in the event of a servicing of the disc brake, a complete exchange of the electronic system with the motor and the control components becomes possible by merely releasing a few fastening elements, such as screws, which clearly simplifies the servicing.

The control device is preferably provided with a control program which is designed for determining the necessity of the initiation of an adjusting operation exclusively by means of information available within the disc brake, particularly without control signals fed to the disc brake from the outside.

In particular, the control device comprises a control computer, such as a microprocessor.

According to a variant, the control device is designed as a self-sufficient unit, so that only a supply voltage has to be fed to the disc brake from the outside.

In this case, it is expedient that only mechanical components, such as a drive shaft or the like, extend from outside of the housing into the interior of the caliper, so that the electronic system will not be exposed to the high temperatures in the interior of the caliper.

Preferably, the adjusting device has, in each case, at least one or two adjusting rotating device(s) arranged on both sides of the brake disc. The housing with the electronic system and a motor can then be arranged on the rear side of the caliper facing way from the brake disc, and, on the opposite side of the caliper, the additional motor without an additional electronic control system can be arranged on the outside of the caliper.

According to a variant, the control device is connected or provided with at least one sensing device integrated in the disc brake. Expediently, this sensing device has a final position sensor, such as a Hall sensor, which is preferably arranged on an element of the brake application device, particularly on the lever arm of the brake rotary lever.

According to a simple constructive variant, the sensing device is a permanent magnet arranged on the lever arm of the brake rotary lever, which permanent magnet, in the inoperative position of the brake rotary lever, generates a first signal condition on a Hall sensor, and in which case the Hall sensor switches to a second signal condition when the permanent magnet together with the brake rotary lever is moved away from the Hall sensor during a braking operation.

In particular, the control device is operated by a control program, which determines the necessity of initiating an adjusting operation using only information available within the disc brake, particularly without control signals fed to the disc brake from the outside.

An adjusting operation is preferably initiated after each braking operation. According to an inventive variant, which can also be considered independently, it is also contemplated as an alternative that an adjusting operation is initiated after a predefined number of braking operations.

According to another variant, an adjusting operation is initiated within the predefined braking time duration.

Particularly preferably, an adjusting operation is initiated at predefined time intervals.

As an alternative, it is also contemplated to sense, by means of sensing devices integrated in the disc brake, whether an adjusting operation has to be initiated.

Summarizing, by means of a control device arranged on, or in, the disc brake, an electric-motor-driven and electronically controlled wear adjusting system for pneumatically or electromechanically operated disc brakes of the above-mentioned type is provided which, with the exception of the voltage supply, is independent of other electric or electronic vehicle systems.

In this case, the electronic control system of the wear adjusting system is completely integrated in the brake, and the necessity of initiating an adjusting operation is determined exclusively within the brake-integrated adjuster control whereby the adjusting operation is carried out.

An adjusting operation can be initiated:
after each braking operation;
after a predefined number of braking operations;
after a predefined braking duration; and/or
at predefined time intervals.

First, the adjusting of the release play at predefined time intervals (time control) will be discussed.

The release play adjustment at predefined time intervals requires the lowest control expenditures but results in a relatively high frequency of adjusting operations because, for protecting operating conditions which may result in a fast change of the operating release play, an adjusting operation is required every 2 to 3 minutes. Such operating conditions exist, for example, during typical high-mounting downhill driving, where a considerable pad enlargement takes place in the warm-up phase at the start of the downhill drive as a result of heat expansion, which is not compensated by a corresponding wear, and an extreme brake pad wear takes place toward the end of the downhill drive because of the high brake pad temperatures.

Assuming that an adjusting operation is carried out every 2 minutes, in the case of a total driving distance of 1 million kilometers,
420,000 adjusting operations take place for a long-distance truck at an average speed of 70 km/h;
1.2 million adjusting operations take place for a city bus at an average speed of 20 km/h.

The high frequency of the adjusting operations requires a particularly wear-resistant design of the mechanical part of the adjusting device and is connected with a higher current consumption and, therefore, with a higher temperature-caused stressing of the electric and electronic components.

The required frequency of the adjusting operations can be considerably reduced when the adjusting takes place as a function of the requirement, for example,
after each braking,
after a predefined number of brakings,
after a predefined total duration of the brakings, which have taken place since the last adjusting operation.

All given possibilities of an adjustment as a function of the requirement necessitate a detection of the braking condition. Since this is to take place without any connection to other vehicle systems, the brake-integrated electronic adjusting system has to be equipped with possibilities of detecting the start and the end of an adjusting operation. This can also take place by means of the measures described in the following, either individually or in a combined manner.

According to a simple variant, a sensing of the movement of a component of the application mechanism, preferably of the brake rotary lever, is contemplated.

Since only a final-position sensor is required here, a microswitch can be used in principle, which is actuated when the rotary lever is moved out of its inoperative position or returns into this inoperative position.

A non-contact detection of the final position can be achieved, for example, by means of a Hall sensor integrated in the electronic adjuster system installed at the caliper head. For this purpose, a small permanent magnet is mounted on the moved component, for example, on the lever arm of the brake rotary lever, which permanent magnet generates a first signal condition at the Hall sensor in the inoperative position of the brake lever and, in the case of which the Hall sensor switches over into its second signal condition when, during a braking operation, the permanent magnet is moved away with the brake rotary lever.

This second signal condition of the Hall sensor clearly identifies the braking condition. It thereby becomes possible to also determine the braking duration and to add up the total braking duration since the last adjusting operation.

The permanent magnet is arranged on the brake lever such that, in the inoperative position of the brake lever, it is capable of correspondingly influencing the Hall sensor integrated in the electronic adjuster system. For this purpose, the electronic adjuster system is advantageously arranged on the caliper head such that the permanent magnet situated on the brake lever and the Hall sensor integrated in the electronic adjuster system have only a distance of a few millimeters in the operative position of the brake rotary lever.

A generating of a rotating movement at the electric motor of the adjusting drive when the brake rotary lever is operated and a detecting of this rotating movement by the position control of the electric motor is also contemplated.

When the brake rotary lever is operated in this variant, a rotating movement is introduced to a shaft of the adjusting transmission, which rotating movement is transmitted by this transmission shaft by way of the intermediately connected gearwheels to the driving motor. Optionally, the rotating movement can also be caused directly at the drive shaft of the electric motor.

Since the driving motor has a device for position control, such as a resolver control or a decoding device, the introduced rotating movement now triggers one or more signal pulses at this decoding device. These signal pulses are transmitted to the electronic adjuster system. The adjuster control thereby determines the rotating movement, and since this rotating movement takes place in the currentless condition of the electric motor, it is clearly recognized as a lever movement. Since the coding device of the electric motor also contains a rotating-direction detecting function, it is also detected from the rotating direction of the electric motor whether the brake rotary lever is operated in the sense of an application movement or whether a return stroke of the lever is present.

In this manner, the start and the end of a braking operation are clearly identified.

By determining the time period between the application stroke and the return stroke of the brake lever, the braking duration can also be determined, whereby also the summation of the total braking duration since the last adjusting operation becomes possible.

The rotating movement of the electric motor can advantageously be caused in that the bearing body of the adjusting transmission is connected with the operating piston of the brake such that, when the brake is operated, it is moved together with the transmission with the brake piston in the direction of the brake disc. This relative movement with respect to the stationary cover plate of the brake housing can now be utilized for generating the rotating movement.

A constant movement of one of the electric motors and the detection of the braking condition by determining the motor stoppage in the energized condition are also expedient.

Another embodiment utilizes the fact that the electric motors of the adjusting device are moved back and forth constantly or slightly with only brief interruptions, for example, only a few rotations. If the brake is being operated, this movement cannot be carried out because the torque generated by the electric motor is not sufficient for overcoming the friction caused at the adjusting screws during braking. The stoppage of the electric motor in the energized condition is clearly recognized by the electronic adjuster system as a braking operation.

The end of the braking operation is determined in the same manner in that it is detected when the motor becomes rotatable again.

In order to minimize the mechanical and thermal stressing of the electric motors, the motor is controlled in the “detection of the braking condition” operating mode preferably by means of a no-load current reduced with respect to the adjusting operation. Furthermore, it is advantageous to carry out the rotating movement alternately by means of the interior and the exterior adjusting drive. Specifically, for detecting the braking, it is sufficient for one of the two electric motors to be stopped. A pause may be inserted between the operations of the electric motors which, however, should not be longer than a normal braking operation. During an adaptation braking, for example, the brake pedal is, as a rule, operated at least for 1.5 seconds. The pause between two operations of the adjusting motors may therefore amount to one second in order to still reliably detect each braking operation.

In the braking detection mode, the average rotational motor speed amounts to, for example, 3,000 (l/min)=50 (l/sec) for a typical design.

The operation of the electric motors in the braking detection mode can therefore take place as follows:

Start
0-0.3 secs motor outside controlled clockwise
0.3-1.3 secs pause (both motors currentless)
1.3-1.6 sees motor inside controlled counterclockwise
1.6-2.6 secs pause
2.6-2.9 secs motor outside controlled counterclockwise
2.9-3.9 sees pause
3.9-4.2 sees motor inside controlled clockwise

In this example, a complete cycle amounts to 4.2 secs. Within a cycle, each motor is acted upon by current for 0.6 seconds. In this example, the switch-on duration of a motor amounts to 14.3%. For each operation, the running time of the motors may also be lower depending on the design of the transmission (amount of the “dead angle of rotation” because of backlashes of teeth and threads). 0.2 secs running time (approximately 10 motor rotations) also seem completely sufficient, whereby the switch-on duration amounts to less than 10%.

In this type of brake detection, the moving direction of the brake rotary lever cannot be immediately detected. In order to identify the start and the end of the braking, the respective previous condition is stored in the electronic adjuster system. The first blocking of one of the two electric motors after their preceding free mobility is identified as a start of the braking; the first free movement of one of the two electric motors after their previous blocking, in contrast, is defined as the end of the braking. In this manner, it becomes possible to determine the braking duration and the total braking duration since the last adjusting operation.

The described methods of the braking condition detection can each be applied individually. However, optionally, the combination of two or more of these methods is also permitted. In particular, it is advantageous to combine the pure time control as a back-up solution with the described method for the requirement-dependent adjuster control. This means that a control is used in the case of which normally the adjuster control is operated by way of a braking condition detection. However, should the latter be ineffective, for example, because of a sensor fault, the adjuster control automatically switches over to the time control.

Additional advantageous characteristics are:
an electrically/electronically controlled wear adjusting system, which is independent of other vehicle systems;
the integration of the electronic control into the brake;
the brake-internal detection of the necessity of an adjusting operation by time control and/or brake-integrated braking condition detection;
the integration of the adjuster control as a preassembled constructional unit including the driving motor and electric connections in a cover accessible from the outside at the brake; and
the integration of the electric driving motor, including the position detection, in the circuit carrier unit.

In the following, the invention will be explained in detail by means of embodiments with reference to the attached figures.

### BRIEF DESCRIPTION OF THE DRAWINGS

FIG. 1 is a sectional view of a disc brake;

FIG. 2 is a view of the arrangement of an adjuster control device at a caliper;

FIG. 3 is a sectional representation of a constructive detail; and

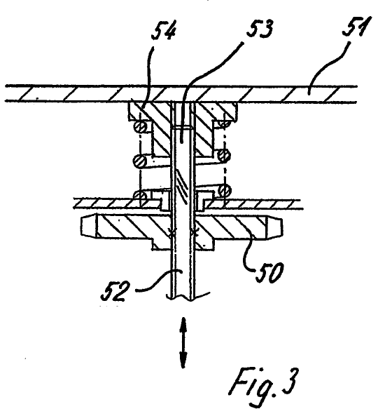

FIG. 4 is a flow chart of a control process.

### DETAILED DESCRIPTION OF THE DRAWINGS

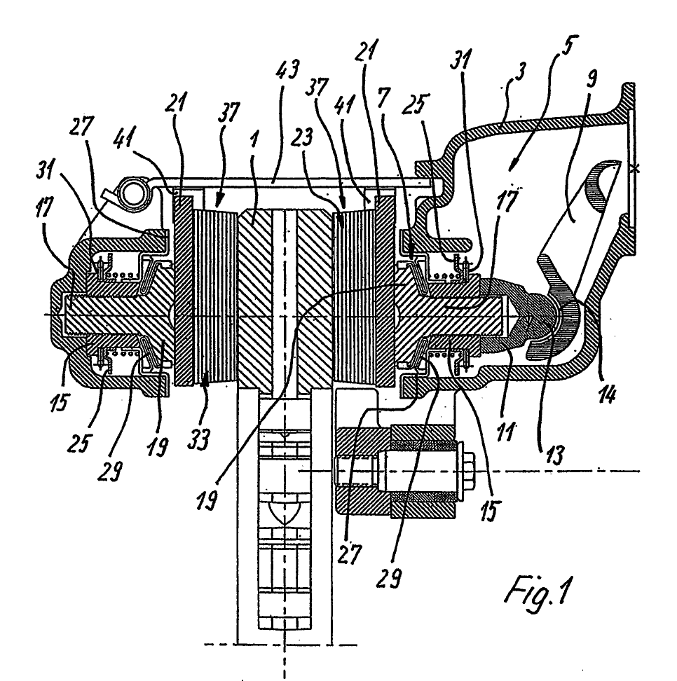

First, the basic construction of the disc brake according to FIG. 1 will be described in order to explain, as an example, the construction of a disc brake with electromagnetically operated adjusting devices arranged on both sides of the brake disc.

FIG. 1 is a sectional view of a sliding caliper disc brake with a caliper 3, which consists of one piece here and extends over a brake disc 1. The invention can also be used in the case of other disc brake constructions, such as sliding-caliper or fixed-caliper brakes.

As an alternative, the caliper 3 can also be constructed in two parts (not shown here), in which case the two caliper parts are preferably mutually connected via studs, and in which case preferably one of the two caliper parts in a frame-type manner surrounds the brake disc in its upper circumferential area, and the additional caliper part is used for receiving a brake application device, which caliper design permits a simple adaptation of the disc brake to application devices of many different constructions.

On one side of the brake disc 1, a brake application device 5 is arranged in the caliper 3, which brake application device 5 can be inserted into the caliper 3 through an opening 7 of the caliper 3 facing the brake disc (also in a completely or partially preassembled manner).

The brake application device 5 has a rotary lever 9, which can be actuated by a piston rod (not shown here) and which is supported on the caliper 3 by way of bearing elements, such as balls and additional bearing shells, not visible here.

On its side facing away from the caliper 3, the rotary lever 9 acts at a center point (or preferably at two lateral ends) in each case upon an intermediate element 11, which has a hemispherical attachment 13 at its end facing the rotary lever. A slide bearing shell 14 is arranged, here, between the attachment 13 and the rotary lever 9.

The intermediate element 11 is supported on the face of an adjusting nut 15 into which an adjusting screw 17 is inserted, particularly in a screwed manner. The adjusting screw 17 carries a pressure piece 19 at its end facing away from the rotary lever 9, which pressure piece 19 rests on a pad holding plate 21 of an application-side brake pad 23.

When the rotary lever 9 is swivelled by the advancing of the piston rod, the lower eccentric-type end of the rotary lever 9 causes an advancing of the intermediate element 11 in the direction of the brake disc 1. In the process, the adjusting nut 15 and the adjusting screw 17 are also pressed in the direction of the brake pad 23 and the application-side brake pad 23 is displaced in the direction of the brake disc 1.

The adjusting nut 15 and the adjusting screw 17 are inserted into two holding plates 25, 27. A bellows-type seal 29 seals off the space between the one holding plate 27 and the pressure piece against the penetration of dirt and moisture.

A gearwheel 31 is non-rotatably-with respect to the adjusting nut-fastened on the adjusting nut. The gearwheel can be operated by way of additional transmission elements, such as additional gearwheels, particularly by an electric motor, which is not shown here, in order to compensate the brake pad wear caused by braking.

When the adjusting nut 15 is rotated, the adjusting screw 17 is moved axially relative to the adjusting nut 15 and the release play between the brake pad and the brake disc is thereby changed. As an alternative, an operation is also contemplated by means of a coupling mechanism connected between the rotary lever 9 and the adjusting nut 15 (not shown here).

Preferably, two of the adjusting rotary drives consisting of the adjusting nut 15 and the adjusting screw 17 are arranged side-by-side on the side of the brake application device 5, so that the brake pad is acted upon by pressure at two points.

Two additional adjusting rotary drives with a preferably separate electric motor drive are arranged on the side of the brake disc 1—the reaction side—facing away from the brake application device in the caliper 3. These adjusting rotary drives also each have an adjusting nut 15 and an adjusting screw 17, which permit the displacing of the pressure piece 19 in the direction of the brake pad 33 arranged on the reaction side of the brake disc 1.

The adjusting of the release play preferably takes place in a computer-controlled manner exclusively by the use of a control device integrated directly into the disc brake.

Since, in each case, at least one separate adjusting device (here, consisting of two adjusting rotary drives with an electric-motor drive) is arranged on each face of the brake disc 1, it becomes possible to construct the caliper 3 in this case as a sliding or hinged caliper. The sliding path or swivelling angle of the caliper is dimensioned such that, by means of it, less than the maximal adjusting (particularly, even only the maximal working stroke), during the application of the brake can be bridged.

For this purpose, the caliper 3 is swivellable relative to a wheel axle or wheel hub fastened on an elastic bearing on a wheel axle or wheel hub. In a supplementary fashion, the brake disc 1 can also be displaceably fastened to the wheel axle or wheel hub. Since the displacing path or swivelling angle to be bridged is smaller than the displacing path or the swivelling angle which a comparable caliper according to the state of the art had to bridge, in the case of which an adjusting device was arranged only on one side of the brake disc 1, it becomes surprisingly possible to implement the displaceability or the swivellability by an elastic linkage between the caliper and the wheel hub or wheel axle.

In such an embodiment, the elastic bearing is arranged parallel to the axis of symmetry of the brake disc; that is, essentially no swivelling movement takes place about the axis of rotation of the bearing, but rather an elastic longitudinal displaceability of the caliper takes place with an elastic swivellability transversely to the longitudinal axis of the bearing, provided here as an ultrabush. In this case, the movement of the caliper for compensating the elasticity is not carried out exclusively as a swivelling movement, whereby particularly adaptation braking is carried out with an almost pure longitudinal displacement of the caliper, and only the rarely occurring braking at high braking forces requires the swivelling of the caliper. As an alternative, two bearings may also be provided, which have swivelling axes parallel to the axis of rotation of the disc (not shown here).

Here, it is important that the adjusting devices are electric-motor-driven; for example, by electric motors arranged between the rotating screws or outside the caliper. The electric motors act by way of a driving connection (which is not illustrated).

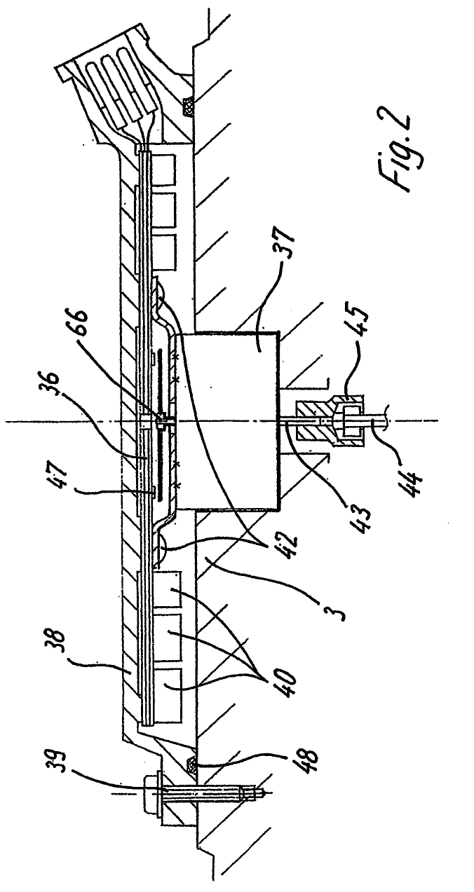

According to FIG. 2, the integration of the electronic control system for the adjusting device is advantageously implemented in that a circuit carrier board (printed circuit board or carrier of a hybrid circuit) 36 accommodating the electronic components is combined for forming a constructional unit with the electric driving motor 37 and a cover 38 also accommodating the electrical connections (plug contacts and/or cable connections. This constructional unit is fastened from the outside to the area of the application housing (caliper 3) facing away from the brake disc, for example, by means of screws 39, to the rear side of the caliper 3 on its side facing away from the brake disc 1 (on the right in FIG. 1).

The housing 38 is adapted as much as possible to the geometry of the caliper 3, so that visually it may under certain circumstances even act as part of the caliper. The motor can be fastened in an uncomplicated manner directly on the printed circuit board 36.

In this fashion, all electric/electronic functions are combined in a preassembled constructional unit, so that, when the brake is assembled, this constructional unit only has to be fastened to the application housing or to the caliper 3 of the brake. This solution is also advantageous during a servicing of the brake in the event of a required exchange of the electric/electronic constructional unit in a motor vehicle workshop.

On a printed circuit board 36 or the circuit carrier of a hybrid circuit, the electronic components 40 of the logic circuit causing the adjuster control are arranged on one or both sides, as well as the power control of the electric driving motor or of the driving motors in the case of a two-sided adjustment. A fastening possibility for the electric driving motor in the form of passage bores, for example, for screws 42 or rivets, exists in the center area of the circuit carrier board.

The electric driving motor has a fastening flange by which the fastening of the driving motor 37 takes place against the circuit carrier board 36 and by means of the latter against the cover 38. The fastening to the cover takes place by means of screws 42 or rivets, the circuit carrier board being clamped between the flange of the driving motor 37 and the cover. For an easier mounting, an additional connection of the driving motor 37 with the circuit carrier board can also take place, for example, by means of hollow rivets through which the studs or riveting pins are guided for the fastening of the entire unit to the cover.

The driving motor 37 has two shaft ends, the first shaft end 43, which faces away from the circuit carrier board, being used for driving the adjusting transmission by way of a plug-type coupling 45 and a transmission shaft 44, and the second shaft end, which faces the circuit carrier board, carrying a decoding rotor 66 which is used for detecting the angular position, the rotational speed and the rotating direction of the driving motor 37.

The decoding rotor is spatially arranged with respect to the circuit board such that the position query or rotational speed query takes place by means of sensors integrated in the electronic circuit.

In this case, the decoding rotor preferably has a disc-shaped construction and has alternately magnetized, radially extending areas. The assigned sensors preferably are Hall sensors 47, which are arranged such on the circuit carrier board that, when the motor shaft is rotating, they are changed by the differently magnetized areas of the decoding disc, which are moved past, into correspondingly alternating switching conditions which are transmitted to the electronic circuit for an analysis.

Other measuring methods are also contemplated; for example, an opto-electronic position and rotational speed detection can also be implemented in the same type of arrangement. Electrical connections in the form of plug contacts leading to the outside are accommodated in the housing 38 or cover, which is preferably constructed of a plastic material. The individual plug contacts are correspondingly connected with the circuit system on the circuit carrier board.

In its surface facing the fastening plane at the application housing, the housing 38 has a surrounding seal 48 as well as screw passage holes in a flange-type widening, by which the preassembled housing unit is fastened by means of studs 39 on the application housing.

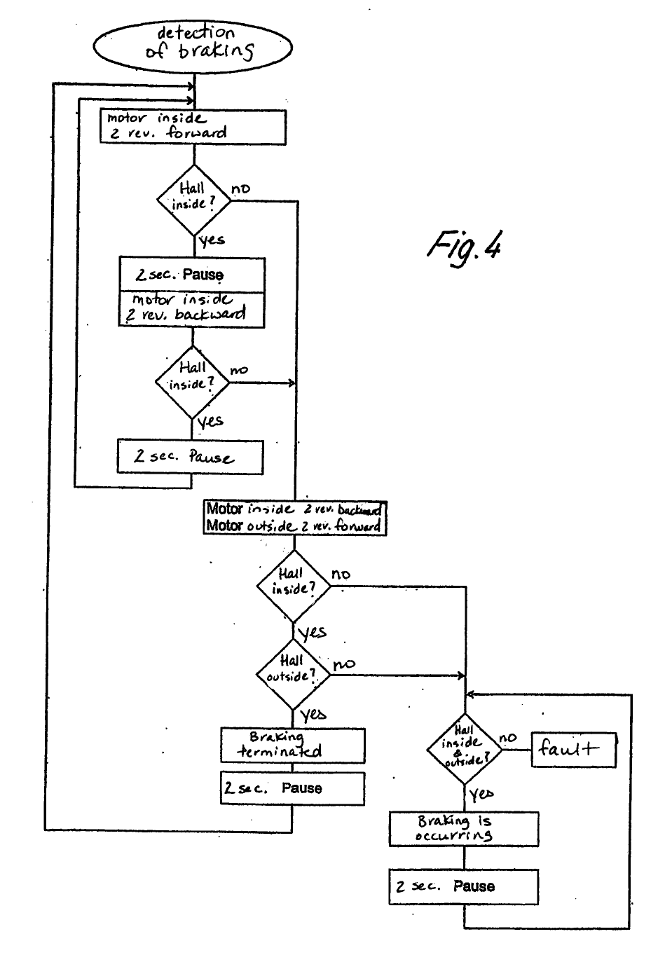

FIG. 4 shows another particularly advantageous embodiment as an example. Here, one of the gearwheels 50 between the electric motor and the adjusting rotating devices has a lengthening of the gearwheel shaft 52, which points in the direction of the stationary cover plate 51. At its end, this gearwheel shaft 52 is equipped with a coarse thread 53, which engages in a threaded nut 54 which is pressed onto the cover plate 51 by means of a pressure spring 55.

When the gearwheel shaft 52 with its coarse thread 53 is now moved into the threaded nut during the operation of the brake, a rotating movement of the gearwheel 50 is necessarily caused. In this case, the transferable torque is limited by the frictional force on the threaded nut 54 which is generated by its spring-elastic contact-pressing against the cover plate 50.

In this manner, it is ensured that a rotation at the adjusting transmission and the electric motor takes place only in the phase of overcoming the release play. As soon as a reaction force of the brake occurs when the brake shoes are placed against the brake disc, the threaded screws are blocked by high frictional forces of the thread and the threaded nut 54 slips with respect to the contact area on the cover plate 50.

Table of Reference Numbers

| | |
|---|---|
| brake disc | 1 |
| caliper | 3 |
| brake application device | 5 |
| opening | 7 |
| rotary lever | 9 |
| intermediate element | 11 |
| attachment | 13 |
| slide bearing shell | 14 |
| adjusting nut | 15 |
| adjusting spindle | 17 |
| pressure piece | 19 |
| pad holding plate | 21 |
| brake pad | 23 |
| holding plates | 27, 27 |
| seal | 29 |
| gearwheel | 31 |
| brake pad | 33 |
| bearing | 59 |
| printed circuit board | 36 |
| driving motor | 37 |
| cover | 38 |
| screws | 39 |
| components | 40 |
| passage bores | 41 |
| screws | 42 |
| shaft end | 43 |
| plug-type coupling | 45 |
| transmission shaft | 44 |
| decoding rotor | 46 |
| sensors | 47 |
| seal | 48 |
| gearwheels | 50 |
| cover plate | 51 |
| gearwheel shaft | 52 |
| coarse thread | 53 |
| threaded nut | 54 |
| pressure spring | 55 |

1-22. (canceled)

23. A disc brake for commercial vehicles, comprising:
a caliper which in use straddles a brake disc;
a brake application device arranged in the caliper, the brake application device being pneumatically or electromotively operable for applying the disc brake;
at least one adjusting device having an electric-motor drive for compensating brake pad wear by adjusting a release play of the disc brake; and
a control device on, or in, the disc brake for controlling said at least one adjusting device having the electric-motor drive.

24. The disc brake according to claim 23, wherein the at least one adjusting device includes at least one adjusting rotating device arranged on each side of the brake disc, each of the at least one adjusting rotating devices acting by way of a respective pressure piece upon a brake pad against the brake disc.

25. The disc brake according to claim 23, wherein the control device is directly integrated in the disc brake.

26. The disc brake according to claim 24, wherein the control device is directly integrated in the disc brake.

27. The disc brake according to claim 23, wherein the control device is arranged at the caliper.

28. The disc brake according to claim 24, wherein the control device is arranged at the caliper.

29. The disc brake according to claim 23, wherein the control device, together with an electric motor of the electric-motor drive, is arranged in a housing at the caliper.

30. The disc brake according to claim 27, wherein the control device, together with an electric motor of the electric-motor drive, is arranged in a housing at the caliper.

31. The disc brake according to claim 24, wherein the control device, together with an electric motor of the electric-motor drive, is arranged in a housing at the caliper.

32. The disc brake according to claim 23, wherein at least one of the control device and an electric motor of the electric motor drive for the at least one adjusting device is integrated in a housing arranged on an exterior side of the caliper.

33. The disc brake according to claim 24, wherein at least one of the control device and an electric motor of the electric motor drive for the at least one adjusting device is integrated in a housing arranged on an exterior side of the caliper.

34. The disc brake according to claim 25, wherein at least one of the control device and an electric motor of the electric motor drive for the at least one adjusting device is integrated in a housing arranged on an exterior side of the caliper.

35. The disc brake according to claim 23, wherein the control device includes a control program for determining a need to initiate an adjusting operation, the control program determining the need exclusively using information available inside the disc brake.

36. The disc brake according to claim 24, wherein the control device includes a control program for determining a need to initiate an adjusting operation, the control program determining the need exclusively using information available inside the disc brake.

37. The disc brake according to claim 23, wherein the control device includes a control computer.

38. The disc brake according to claim 35, wherein the control device includes a control computer.

39. The disc brake according to claim 23, wherein the control device is a self-sufficient unit requiring only a supply voltage fed from outside the disc brake.

40. The disc brake according to claim 35, wherein the control device is a self-sufficient unit requiring only a supply voltage fed from outside the disc brake.

41. The disc brake according to claim 32, wherein only mechanical components extend out of the housing into an interior of the caliper.

42. The disc brake according to claim 24, wherein at least two adjusting rotating devices are arranged on each side of the brake disc.

43. The disc brake according to claim 23, wherein the control device is coupled with at least one sensor integrated in the disc brake.

44. The disc brake according to claim 35, wherein the control device is coupled with at least one sensor integrated in the disc brake.

45. The disc brake according to claim 43, wherein the at least one sensor includes a final position sensor.

46. The disc brake according to claim 44, wherein the at least one sensor includes a final position sensor.

47. The disc brake according to claim 43, wherein the at least one sensor includes a Hall sensor.

48. The disc brake according to claim 45, wherein the final position sensor is arranged on a component of the brake application device.

49. The disc brake according to claim 48, wherein the component is a lever arm of a brake rotary lever of the brake application device.

50. The disc brake according to claim 43, wherein the sensor is a permanent magnet arranged on a lever arm of a brake rotary lever of the brake application device which, in an operative position of the brake rotary lever, generates a first signal condition on a Hall sensor, and in which case the Hall sensor switches to a second signal condition when a permanent magnet together with the brake rotary lever is moved away from the Hall sensor during a braking operation.

51. A disc brake for commercial vehicles, comprising:
a caliper which in use straddles a brake disc;
a brake application device arranged in the caliper, the brake application device being pneumatically or electromotively operable for applying the disc brake;
at least one adjusting device having an electric-motor drive for compensating brake pad wear by adjusting a release play of the disc brake;
at least one sensor integrated in the disc brake; and
a control device coupled with the at least one sensor.

52. A method of controlling a disc brake in which at least one adjusting device having an electric-motor drive with an electric motor, the method comprising the acts of:
compensating brake pad wear of the disc brake by adjusting a release play of the disc brake using the electric-motor drive of the at least one adjusting device; and
controlling the at least one adjusting device via a control device directly integrated in the disc brake.

53. The method according to claim 52, wherein the control device is operated via a control program, the controlling act further comprising the act of determining a need to initiate an adjusting operation exclusively using information available within the disc brake and without control signals fed from outside the disc brake.

54. The method according to claim 53, wherein the adjusting operation is initiated after each braking operation.

55. The method according to claim 53, wherein the adjusting operation is initiated after a predefined number of braking operations.

56. The method according to claim 53, wherein the adjusting operation is initiated within a predefined braking time period.

57. The method according to claim 53, wherein the adjusting operation is initiated at predefined time intervals.

58. The method according to claim 53, further comprising the act of sensing via at least one sensor integrated in the disc brake whether the adjusting operation has to be initiated.
